(19) United States
(12) Patent Application Publication
(10) Pub. No.: US 2017/0105361 A1
(43) Pub. Date: Apr. 20, 2017

(54) MULTI-PLANT BIOACTIVE COMPOSTING POTS

(71) Applicants: VIJAYAN THIRUMALAI ANANDAMPILLAI, Chennai-88 (IN); APARNA THIRUMALAI ANANDAMPILLAI, Chennai-88 (IN)

(72) Inventors: VIJAYAN THIRUMALAI ANANDAMPILLAI, Chennai-88 (IN); APARNA THIRUMALAI ANANDAMPILLAI, Chennai-88 (IN)

(21) Appl. No.: 15/128,191

(22) PCT Filed: Mar. 24, 2015
(86) PCT No.: PCT/IN2015/000138

§ 371 Date: Sep. 22, 2016

(30) Foreign Application Priority Data
Mar. 26, 2014 (IN) 1594/CHE/2014

(51) Int. Cl. A01G 9/02; B65F 1/14; A01G 9/08; A01G 9/12; A01G 1/00

(52) U.S. Cl. CPC A01G 9/028; A01G 9/12; A01G 1/001; A01G 9/081; B65F 1/14; B65F 2001/1489; B65F 2240/00

(57) ABSTRACT

This multiplant bioactive composting pot of chosen shape, size, and material has a central composting chamber (1) with two or more outer plant chambers(2) separated by a partition (4) forming soil loaded plant and waste loaded composting parts. Each plant chamber has water drain hole (6) on the side, an inside a stem support insert (7) and is filled with soil. The compost chamber is pre-coated with composting microbes. The compost chamber has a lid (3)in rainy& snowy areas. The waste is composted in few days. The plant roots grow into partition holes (5) and suck up this nutrition for faster growth and more yield. Any excess water is drained out by hole (6) in the soil part. Series of these pots form an organic garbage garden to add nutrition and clean up air too.

### TECHNICAL FIELD

This invention in general relates to bioactive garden pots with built in composting of organic wastes and many plants growing in the same pot in different plant chambers.

### STATE OF ART

All homes, hotels generate organic wastes from eating that includes vegetables, meat, fish etc left overs that is sent to city dumping yard creating air, water and land pollution. If all organic waste is composted and used up as fertiliser in garden pots for growing fruit or vegetable plants, we can save on waste disposal cost and food buying costs. Plants alone reverse air pollution. Plants trap air dust, CO2, give Oxygen, and purify city air-very much needed in reducing global warming.

Ideal composting garden pots should be: 1. it grows many plants in the same pot. 2 It should be clean, smell free composting. 3 It allows plants to use up the organic wastes 4. Easy to plant, run and use. 5. Safe and reliable. There are no simple pots as of now!

The following description gives critical examination of the pots for planting known in the art. It also discusses the shortcomings of the conventional methods. Further in order to overcome the problem associated with composting, the invention offers the solution to overcome the impediments in the construction and the process of using the same.

Constraints in all garden pots are as follows:
1. Do not grow multiple plants, if so plants are not getting light and nutrients equally.
2. There is no composting.

Accordingly the object of the invention is to identify the solutions for problem associated with the multiple plant growing pots. An extensive search has been carried out using the Internet and related patent specifications were studied for pots that can compost and allow many plant growth in same pot. Since the present invention is radically different, in using the same pot for composting and plant growth, the inventors are unable to site any patent specification out of the available databases except WO2011080760 also invented by us. This pot had no multiple plant chambers, had no bioactive microbes for faster decomposition of wastes. If 2 or more plants were grown in same pot, limited sun & nutrients decreased growth. It had hole covering sliding plate, eliminated in this new pots The invention is directed to a novel type of easy, faster composting (bio-active) multiple plant growing pots for use even by kids and women too, at home.

Accordingly it is the primary object of the invention to invent a novel faster composting pot with multiple plant growing, which is unique in design and construction, working and use. Further objects of the invention will be clear from the ensuing description.

### SUMMARY OF THE INVENTION

The device comprises of a bioactive pot with a central large organic waste composting chamber precoated with composting microbes and their nutrients. The microbes bioactively decompose organic wastes faster. This composting chamber has two or more outer radiating plant chambers with a partition with holes for roots to grow into composting chamber. Plant roots suck up the nutrients from the composted wastes to grow faster and yield more fruits and vegetables. The plant chamber of pot is filled with garden soil, seeded for plant growth. The daily organic waste is dumped into the composting chamber preseeded with composting germs to convert organic waste to fertiliser and yields the nutrients to the root of plant for faster, better growth. The organic waste grows plants giving eatable food in weeks. The plants in different chambers of pot grow without shading others. The pots can be placed indoors or on windows, roof tops, sit outs with open sunny place. The pots will be made in various sizes depending on the plant hight, root system and its yield.

A series of pots of can use all home organic waste eternally with different types of plants (each two for cross pollination.) as free safe home nutrition with no city organic garbage collection, transport, disposal costs now running into millions.

### STATEMENT OF DRAWINGS

These and other objects and features of the invention will become more apparent upon perusal of following description taken in conjunction with accompanying drawings wherein:

FIG. 1 shows the details of composting pot.

FIG. 2 shows the various components of a pot.

FIG. 3 shows the exploded view of the pot plant growth.

FIG. 4 shows a modification for rectangular chambers

### DESCRIPTION OF PREFERRED EMBODIMENTS

The following specification describes salient features of invention, the method of construction, the method of use and the advantages of the novel invention.

The novel device has a pot made of plastic, clays, metal or earth. The novel pot according to invention is better because the all organic waste is segregated& used up at home. The plants in few weeks give vegetables or fruits too. The city avoids organic garbage collection cost. Vegetables is now grown at home at low cost and in plenty. Oxygen is increased, carbon dioxide is trapped by plants. Home and City air is now healthy. Special feature of the invention is that it is easy to set up, run, and use even by illiterates or kids too.

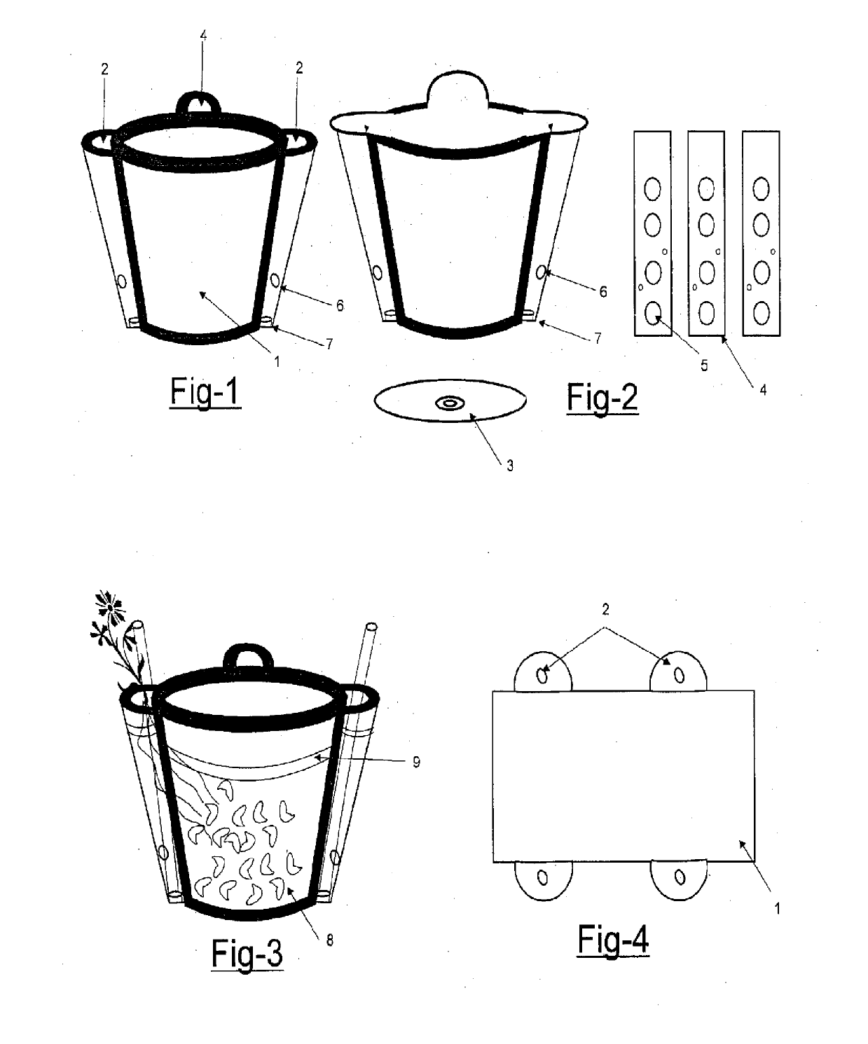

The device comprises of an appropriate sized garden pot FIGS. 1, 2, with a central composting chamber 1, and multiple radiating plant chambers 2. Removable partitions 4 provided with holes 5 for roots to separate plant and composting wastes. The compost chamber is covered by a lid 3 for heavy rain/snowy areas. Water drain 6 in each plant chamber is on the side to remove excess water. There is no bottom drain as waste leachate water is nutrient laden and in our pots used up by the growing plants. Each plant chamber has a stem support insert 7 for a plastic pipe around which the plant stem is supported. Various micro organisms for fat, proteins, celluloses, bone, and meat decomposition are collected from soil, grown, mixed together, suspended in a microbial broth with microbial nutrients and sprayed or brushed to coat inside of compost chamber. This dries fast. When organic waste with water is added, this coating spreads the microbes into wastes and soon reduce it to nutrients for growing plants. Soil microbes not harmful to humans are used.

FIG. 3 shows the working of pot. The partitions are fitted in plant-compost chamber junction. The plant chambers are filled with garden soil and planted. The composting chamber is aldready primed with composting microbes & germs for decay of the organic waste. The organic waste 8 is dumped into compost chamber and covered with 1 inch of soil 9. The plant roots pass into compost chamber through root holes 5 of the partition 4, take nutrients and show faster plant growth. The organic waste is better filled as a mashed waste to decrease the composting time. Smaller pieces are faster decomposed than larger pieces. The germs convert all organic wastes—left overs, bones, meat etc to fertiliser. The broken down proteins, fats, carbohydrates are absorbed by plant roots for growth. Nitrates, phosphates minerals etc are also absorbed by roots. Growing two plants of same species in two pots helps easy cross pollination and more yield. When the plant dies, the soil is taken out, sun dried and used again. Old plant is composted. Climbing plants need stem support in growth. Plastic pipes fixed in inserts 7, FIG. 3 is a good support for plant's stem on windy days. The plastic pipes can be joined by cross bars as support scaffold for climbers plants as snake gourd, beans, etc to spread. A plastic film may be spread on top of soil in the pot to prevent water evaporation in hot day. The compost chamber can be closed by lid 3 in rains or snow. All sunny open parts of home—roof, balcony, door steps and land for placing the pots—can be used adding to beauty of the house with ecoadvantages. Non-vegetarian wastes are usually dumped in bottom, then dinner wastes, vegetable peels and finally covered with 3 centimeters of soil 9. Water the plant part, not waste chambers. Appropriate organic insecticides for pests can be used in flowering stage. Plant chambers are 6-9 inches apart for good growth. The pot decomposes wastes in 10-20 days vs 2 or more months of composting.

FIG. 4 shows a modification for rectangular multi plant pot with four plant chambers 2.

The pots can be modified. They may be made from earth, clay, porcelain, metals, plastics of any safe type, cast or moulded. The pots may be of any shape, size needed with outside ornamentation. The composting chamber may be of any shape-circle, square, hexagon etc. The partition whole size& number may be varied for different plants—more for roots with more branches. Plant—waste junction may have grooves in which the partitions are fitted. Wheels may be provided for shifting pots. The die for pot is cast as for buckets. Partition and compost chamber lid is made in separate dies. The waste chamber top rim is strengthened for lifting. Plastic pots are UV stablised for long years of outdoor use. The pots may be used in green houses for lesser pest's attacks.

It will be apparent to those skilled in the art that modifications to the invention described herein can readily be made without departing from the spirit of the invention. Protection is sought for all the subject matter described herein including any such modifications.

### Advantages of the New Invention

1. Organic waste now grows healthy chemical free food at home.

2. Cost of city organic garbage collection, transport, dumping and landfill site is saved.

3. Nutrition increases with lower air CO2, more Oxygen & clean air too.

4. Water use is lesser as drains are on sides, not in bottom.

We claim:

1. an multiplant bioactive composting pot comprising of a central composting chamber (1), of needed shape and size and provided with two or more outer plant chambers (2), the pot has on its inside a partition (4) between each plant chamber and the central waste chamber, this partition (4) having multiple root holes (5), the plant chamber has an excess water drain hole (6) on the side and is filled with soil and planted.

2. An multiplant bioactive composting pot as claimed above, wherein the plant chamber in the floor has stem support inserts (7) for plant stem supporting poles.

3. A multiplant bioactive composting pot as claimed in claim 1, wherein various safe microbes for decomposing organic wastes—proteins, sugars, fats, cellluoses, skin, bones are suspended in solution with microbial nutrients, coated to the inside of composting chamber and dried.
